(19) United States
(12) Patent Application Publication
(10) Pub. No.: US 2008/0296356 A1
(43) Pub. Date: Dec. 4, 2008

(54) INSULATED FOOD CRATE

(76) Inventors: John August Hatcher, Auburn, WA (US); Amy Hatcher, Auburn, WA (US)

Correspondence Address: Oliver Law Firm, PS Inc., 7907 Alma Blvd., Waxhaw, NC, 28173, US

(21) Appl. No.: 12/129,690

(22) Filed: May 30, 2008

Related U.S. Application Data
(60) Provisional application No. 60/932,482, filed on May 30, 2007.

(51) Int. Cl. B65D 81/38; B65D 25/04; B65D 5/42; B31B 1/74

(52) U.S. Cl. 229/103.11; 229/120.02; 229/120; 220/592.2; 493/84

(57) ABSTRACT

An insulated food crate comprises a generally rectangular, typically cardboard box having separable top and bottom portions with double walls providing insulative properties and also insulating inserts fitted into the top and bottom portions. The box may also have ventilation holes or slots and/or compartments for serving utensils and may be disposable. In alternate embodiments, the insulated food crate may be made from a heat-resistant composite material, such as a reinforced plastic or stainless steel, as a more permanent, durable, and reusable solution. This inexpensive, accessible catering box keeps hot foods hot and cold foods cold while allowing quick and easy access to the foods inside.

### RELATED APPLICATIONS

This application is related to and claims priority under 35 U.S.C. 119(e) to U.S. provisional application Ser. No. 60/932,482, entitled “Insulated Food Crate,” filed on May 30, 2007, with inventors John Hatcher and Amy Hatcher, both of Auburn, Wash., which is hereby incorporated by reference in its entirety.

### FIELD OF THE INVENTION

This invention pertains generally to food containers and more particularly to an insulated food crate for transporting hot or cold foods while maintaining temperature.

### BACKGROUND OF THE FIELD

In many situations, such as catering, foods are to be consumed in a dining location that is different from the source location where they were created—usually a kitchen. This need for transportation becomes particularly problematic when there is a need to maintain the temperature (e.g., hot or cold) of the recently prepared foods. Historically, there has been a need for sturdy containers having good insulative characteristics and water retaining capabilities for use in shipping perishable food products, such as dressed poultry. Although there are some products currently on the market for addressing this problem on a relatively large scale, they are either too expensive or have some structural or functional problem. However, there still exists a need for a simple, disposable solution for smaller volume catering and for ease of use.

There are several prior art patents that have addressed this issue in various ways. For instance, U.S. Pat. No. 4,017,016 to Ivy discloses a shipping container with separable top and bottom portions. However, Ivy's device does not have integral double walls around the sides of the top and bottom portions, and also does not offer any insulation above or below the food dish carried therein. Furthermore, Ivy's device cannot work without the insulating insert around the sides, because the top and bottom portions will not fit together without said insert. U.S. Pat. No. 6,196,448 to Correll discloses an insulating food carton. However, Correll's device is a one-piece closed box used only for transporting food dishes and does not offer easy access to the food therein. Cadiente's shipping container (U.S. Pat. No. 5,638,978) is intended for use with refrigerated produce—especially floral products—and so is designed with corner gussets and is made watertight with a continuous barrier.

### SUMMARY OF THE INVENTION

The present invention solves the above-mentioned problems by providing a simple and effective way for hot foods to be transported from the kitchen to the dining location that is easy to use and useful on a relatively small scale. The present invention may be composed of various materials, including cardboard, plastic, stainless steel, or any other type of insulating materials. It may be constructed in various sizes, colors, designs, or shapes, and it may or may not have a carrying handle with various designs and styles. One aspect of the invention may comprise a generally rectangular cardboard box having separable top and bottom pieces having side and end walls made to overlap one another, the pieces being formed from flat patterns being cut, scored, notched, and folded. In addition, the present invention may comprise a plurality of ventilation ports, holes, and/or slots or other openings for maintaining food temperature, and include a plurality of inner compartments and/or channels for accommodating a plurality of accessories, condiments, and/or utensils. In another embodiment, the top and bottom sections are folded to comprise double-walled ends (short sides) and [long] sides for insulating the inner compartment(s).

The present invention may also embody insulating inserts or boards. As with the box itself, the insulating inserts or boards may also be composed of various insulative materials with varying sizes and shapes. As mentioned previously, one aspect of the invention may comprise a rectangular cardboard crate having separable top and bottom pieces which nest together and may be linked to insulating inserts. (Such inserts may be fitted to any one or more of the top, bottom, short or long sides of the crate.)

In alternate embodiments, the insulated food crate may be made from a heat-resistant composite material, such as a reinforced plastic, Styrofoam, or cardboard, or other, to be a more permanent, durable and reusable solution. The plastic or other insulating material may also have two separate parts, a bottom and top in which the top section covers over the bottom section, or two hinged parts with a top handle for opening and closing the container. The plastic container may come in various shapes, sizes and color.

Another embodiment may include a stainless steel material with or without additional internal insulators for consistent temperature maintenance, durability and easy cleaning. The container may be constructed in various shapes and sizes to fit the required food packages. This particular stainless steel embodiment may also compose of two main separable overlapping parts or connected parts by a hinge means.

### BRIEF DESCRIPTION OF THE DRAWINGS

The foregoing aspects and the attendant advantages of this invention will become more readily appreciated as the same becomes better understood by reference to the following detailed description, when taken in conjunction with the accompanying drawings, wherein:

FIG. 1 is a plan view of a preferred embodiment of the present invention illustrating a flat pattern of cardboard having been cut, scored, and notched prior to being folded into a rectangular top or bottom portion;

FIG. 2 is an exploded side view illustrating a top portion made to overlap and nest with a bottom portion, two insulating inserts, and a single food container therein;

FIG. 3 is a perspective view of the present invention illustrating the top portion overlapping and nesting with the bottom portion to create a two-piece shell;

FIG. 4 is a side sectional view illustrating the double-walled ends, two insulating inserts—one top insert and one bottom insert—and one food container in the inner space;

FIG. 5 is a plan view of an alternate embodiment illustrating a flat pattern of cardboard having been cut, scored, and notched prior to being folded into a rectangular top or bottom portion; and

FIG. 6 is an alternate side sectional view illustrating the double-walled sides of one portion and the single-walled sides of the other portion resulting in triple layer insulating material.

### DETAILED DESCRIPTION

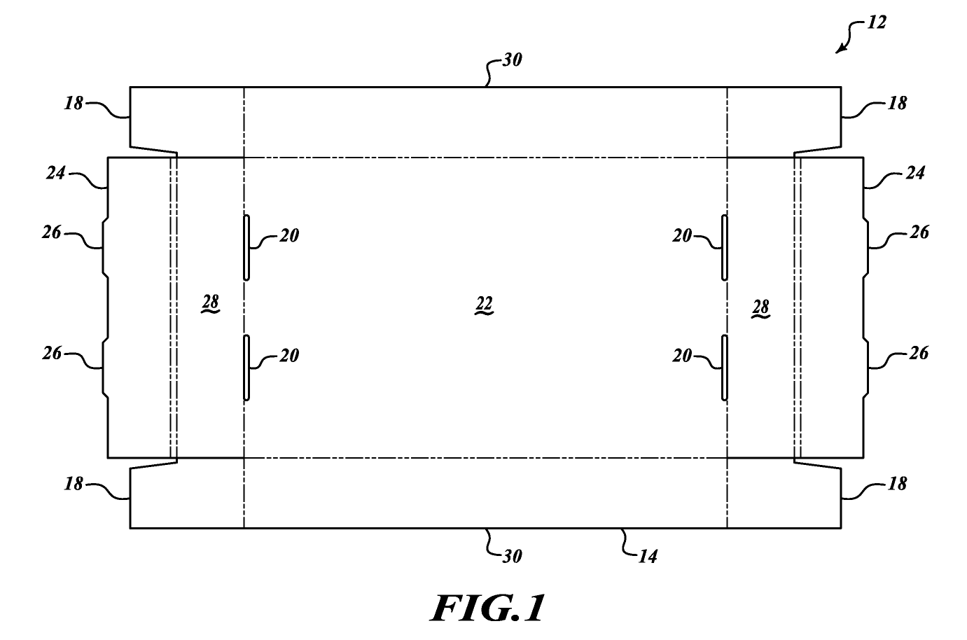

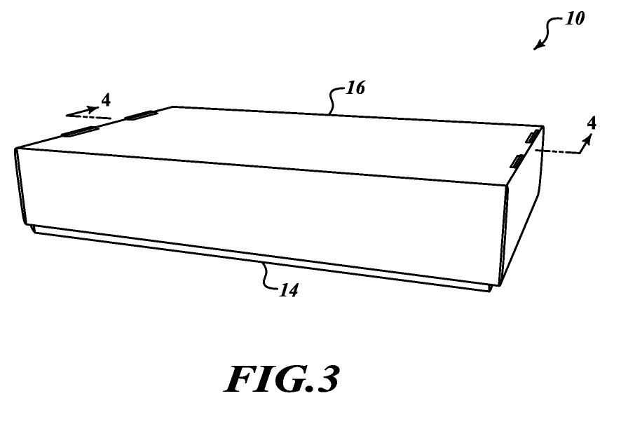

FIG. 1 shows a flat pattern 12 as it may be cut, scored, and notched to create the insulated food crate 10 (shown in FIG. 3). Although this discussion will be in reference to the bottom portion 14, the reader understands that the top portion 16 is identical except for the size. The dimensions of the top portion may be slightly larger so that the two portions will nest together with overlapping sides as shown in FIG. 3.

The flat pattern 12 shown here is a single piece of insulating material to be cut along the solid lines and folded along the dotted and dashed score lines in order to create the generally rectangular bottom portion 14 of the insulated food crate. The side tabs 18 will be folded towards the notches 20 as the side walls 3U are folded up. (Notches 20 serve also as ventilation openings, slots, or ports. More ventilation openings, slots, or ports, could easily be provided in other locations on the flat pattern.) On each end of the generally rectangular bottom panel 22, the inner layer 24 will be folded so that the end tabs 26 will be inserted into the notches 20 (over the folded side tabs 18), thereby doubling the end wall 28 (or actually tripling it—toward the corners because of side tabs 18). The bottom portion then becomes a generally rectangular bottom panel, or box bottom, with fours sides extending upwardly therefrom, and the top portion becomes a generally rectangular top panel, or box top, with fours sides depending therefrom.

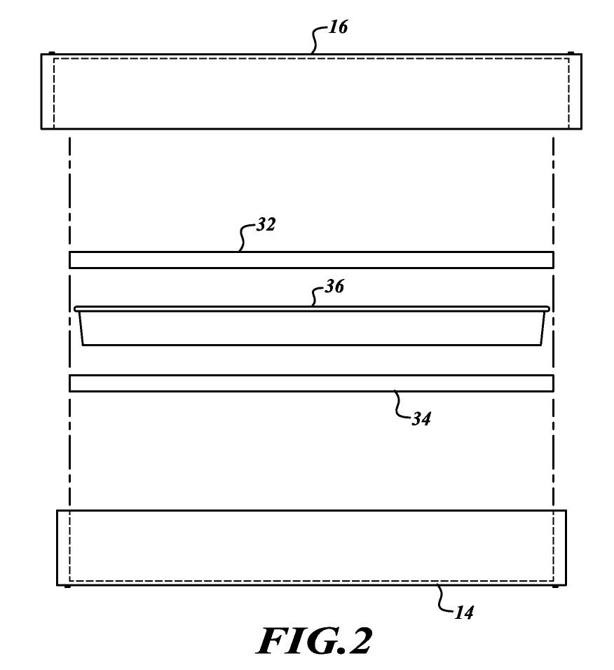

FIG. 2 shows a possible method of nesting the top portion 16 with the bottom portion 14 to create the insulated food crate 10 of the invention. The generally rectangular insulating inserts 32 and 34 (in this illustration there are two inserts; in alternate embodiments a different number of inserts could be used) may be positioned within the portions to help maintain the temperature of the food dish(es) 36. (As many dishes as desired may be included in the food crate. Typically, only one dish is used, because the food crate is typically designed to hold the standard size of catering dish.) One insert 34 will typically be placed in the bottom portion 14, then the food dish(es) 36 will be placed on top of the insert 34 and covered with the insert 32, and then the top portion 16 will be linked so as to nest with the bottom portion, resulting in a six-sided food crate that is insulated on at least four sides. The box portions being folded as described will result in a double layer of insulating material on at least one side of each portion—typically on both ends (short sides) or both [long] sides. Then upon assembly, the box will have quadruple layers of insulating material on the ends (short sides) and double layers of insulating material on the long sides. The inserts provide extra insulation on the top and bottom of the box. Therefore, the food dish(es) will be insulated all around—i.e., on all six sides. These insulating inserts may be made from Styrofoam, cardboard, or any other appropriate insulating material and can be simply placed inside the inner space of the box or can be linked in some other way.

FIG. 3 shows how the top and bottom portions nest closely together to form the insulated food crate of the invention. The insulated food crate its therefore a two-piece shell assembled to form a six-sided crate, which when made according to the above directions will provide an inner space 40 in the general shape of a parallelepiped. In alternate embodiments, the inner space may be further compartmentalized—by additional inserts or in some other way—to allow for the inclusion of e.g., serving utensils or condiments. A section along the lines 4-4 in the next figure will illustrate this inner space. In most embodiments, including the one shown, the top panel will be made slightly larger than the bottom panel so that the two portions (resulting from folding) will nest closely together to create the inner space.

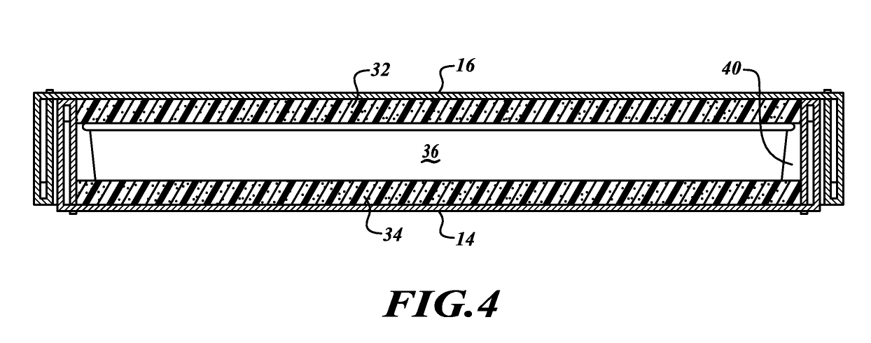

FIG. 4 shows an interior view of a fully packed catering food crate 10 according to the invention. The food dish 36 being insulated (whether hot or cold) is positioned within the inner space 40 such that it is insulated on the top and the bottom by at least two layers—the insulating insert 32 or 34 and the top or bottom panel 14 or 16. The food dish is further insulated on the ends (short sides) of the crate by at least four layers of insulating material (the double end walls of the top portion adjacent the double end walls of the bottom portion), and on the long sides by at least two layers of insulating material (the side walls of the top portion adjacent the side walls of the bottom portion). To use the insulated food crate of the invention to transport hot or cold food, a user having prepared the food in the catering dish and heated or cooled it to the desired temperature builds the food crate by folding the bottom portion from a flat panel, placing an insulating insert therein linked to the bottom portion, placing the food dish thereon, placing an insulating insert thereon, folding the top portion from a flat pattern, and nesting the top portion with the bottom portion to define a two-piece shell.

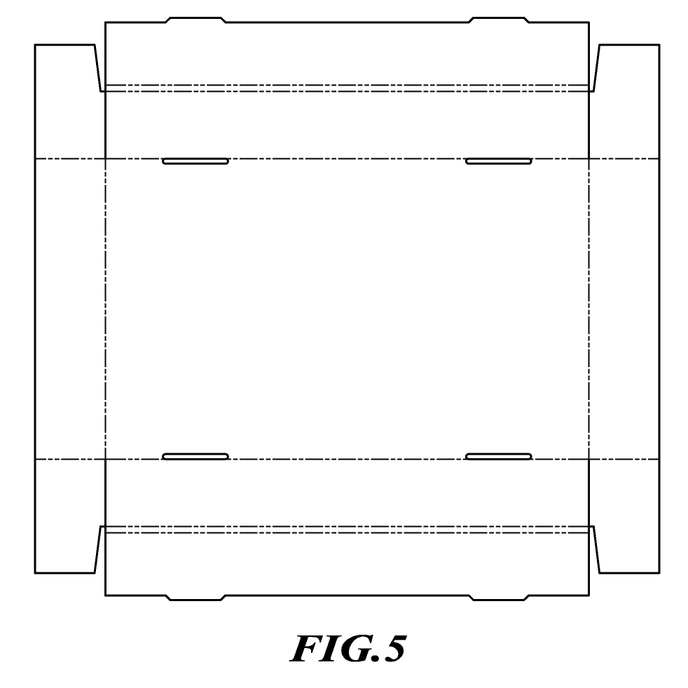

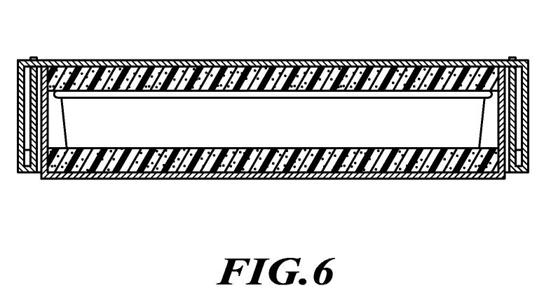

FIG. 5 shows a flat pattern for use with an alternative embodiment having insulation on all six sides of the box. In this embodiment, one of the box portions (bottom or top) will be made according to FIG. 1—with ends (short sides) being double-walled, and the other portion (top or bottom) will be made according to FIG. 5—with long sides being double-walled. In this way, when the portions are nested, there will be double walls on all four sides of the box—resulting in at least three layers of material on each side and each end. Adding the insulative layers above and below the food dishes will complete the all-around insulation. FIG. 6 is a sectional view similar to FIG. 4 showing the double-walled insulation which is typical on all sides and ends of the box and showing how on assembly, there will be triple layers on insulating material all around.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. An insulated food crate comprising:
a two-piece shell including a top-portion and a bottom portion,
wherein said top portion nests with said bottom portion, and
including a plurality of insulating inserts within said shell for maintaining the temperature of a food dish carried therein.

2. The insulated food crate of claim 1 wherein said top portion comprises a single piece of insulating material folded along score lines into a generally rectangular box top having a top panel and four sides depending therefrom and having a double layer of said insulating material on at least one side.

3. The insulated food crate of claim 2 wherein said bottom portion comprises a single piece of insulating material folded along score lines into a generally rectangular box bottom having a bottom panel and four sides extending upwardly therefrom and having a double layer of said insulating material on at least one side.

4. The insulated food crate of claim 3 wherein said top panel is slightly larger than said bottom panel so that said top portion and said bottom portion nest with each other to define a shell with an inner space to accommodate at least one food dish.

5. The food crate of claim 1 wherein said insulating inserts are generally rectangular in shape and fit within said shell above and beneath said food dish.

6. The food crate of claim 5 wherein each of said inserts is made from styrofoam.

7. The insulated food crate of claim 4 wherein said shell is generally a parallelopiped with two short sides and two long sides, a top and a bottom, and wherein said short sides comprise quadruple layers of said insulating material and said long sides comprise double layers of said insulating material.

8. The insulated food crate of claim 7 wherein said insulating inserts link to said top and said bottom of said shell such that said inner space is also generally a parallelopiped in shape with insulation on all six sides.

9. The insulated food crate of claim 4 wherein said shell is generally a parallelopiped with two short sides and two long sides, a top and a bottom, and wherein said short sides and said long sides each comprise triple layers of said insulating material.

10. The insulated food crate of claim 9 wherein said insulating inserts link to said top and said bottom of said shell such that said inner space is also generally a parallelopiped in shape with insulation on all six sides.

11. An insulated six-sided crate comprising separable top and bottom overlapping portions defining an inner space for insertion of at least one catering dish.

12. The insulated crate of claim 11 wherein said portions define a plurality of openings for ventilation.

13. The insulated crate of claim 11 wherein said portions define a plurality of compartments to compartmentalize said inner space.

14. The insulated crate of claim 11 further comprising insulating inserts to be positioned within said inner space.

15. The insulated crate of claim 14 wherein said insulating inserts surround a food dish such that said dish in insulated on all sides.

16. A method for transporting hot or cold food using an insulated food crate, wherein said crate comprises separable, nested top and bottom portions folded from flat patterns and providing insulation on all sides, said method comprising the steps of:
(a) preparing said food in a catering dish including heating or cooling said food,
(b) folding the bottom portion of the food crate from a flat pattern,
(c) inserting an insulating insert into the bottom of the bottom portion,
(d) inserting said catering dish,
(e) inserting an insulating insert on top of said catering dish,
(f) folding the top portion from a flat pattern, and
(g) nesting said top portion onto said bottom portion to define a shell.

17. The method of claim 16 wherein said insulating inserts are made from an insulative material chosen from the group comprising styrofoam and cardboard.

18. The method of claim 16 wherein said bottom portion when folded provides double-walled ends and said top portion when folded provides double-walled ends.

19. The method of claim 16 wherein said bottom portion when folded provides double-walled ends and said top portion when folded provides double-walled sides.

20. The method of claim 16 wherein said bottom portion when folded provides double-walled sides and said top portion when folded provides double-walled ends.
